(19) United States
(12) Patent Application Publication
(10) Pub. No.: US 2021/0382760 A1
(43) Pub. Date: Dec. 9, 2021

(54) RESOURCE ADJUSTMENT DEVICE, NON-TRANSITORY COMPUTER-READABLE MEDIUM AND RESOURCE ADJUSTMENT METHOD

(71) Applicant: FUJITSU LIMITED, Kawasaki-shi (JP)

(72) Inventors: Toru Nakayama, Machida (JP); Yuuki Ogata, Kawasaki (JP)

(73) Assignee: FUJITSU LIMITED, Kawasaki-shi (JP)

(21) Appl. No.: 17/190,465

(22) Filed: Mar. 3, 2021

(30) Foreign Application Priority Data
Jun. 5, 2020 (JP) 2020-098531

(51) Int. Cl. G06F 9/50; G06F 9/455; G06Q 10/06

(52) U.S. Cl. CPC G06F 9/5077; G06Q 20/145; G06Q 10/06313; G06F 9/45558

(57) ABSTRACT

A resource adjustment device includes a memory, and a processor coupled to the memory and the processor configured to set a ranking to each of a plurality of first virtual machines according to an amount of resource used by each of the plurality of first virtual machines in operation, and allocate the resource of the first virtual machine having a highest of the ranking to a second virtual machine before starting.

### CROSS-REFERENCE TO RELATED APPLICATION

This application is based upon and claims the benefit of priority of the prior Japanese Patent Application No. 2020-098531 filed on Jun. 5, 2020, the entire contents of which are incorporated herein by reference.

### FIELD

A certain aspect of the embodiments is related to a resource adjustment device, a non-transitory computer-readable medium, and a resource adjustment method.

### BACKGROUND

With the development of virtualization technology, cloud services that provide various services to users using virtual machines running on physical servers are spreading. One of the cloud services is a dedicated cloud service. In the dedicated cloud service, a service provider manages a physical server owned by a user, and the service provider starts the virtual machine on the physical server to provide the various services to the user.

In this case, the service provider charges the user a service fee according to an amount of physical resources reserved for the virtual machine. Such resources include a memory, for example. In this case, the service provider charges the user a fee according to a reserved memory usage.

However, under such a fee system, the user pays a fee based on the reserved memory usage even when the virtual machine is actually using only a part of the reserved memory usage, causing the user to unnecessarily bear the fee. Further, the service provider needs to add memories to the physical server to secure the memory usage that is not actually used, which causes wasteful investment for operating the cloud service. Note that the technique related to the present disclosure is disclosed in Japanese Laid-open Patent Publications No. 2005-031929 and No. 2005-078604.

### SUMMARY

According to an aspect of the present disclosure, there is provided a resource adjustment device including a memory, and a processor coupled to the memory and the processor configured to set a ranking to each of a plurality of first virtual machines according to an amount of resource used by each of the plurality of first virtual machines in operation, and allocate the resource of the first virtual machine having a highest of the ranking to a second virtual machine before starting.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a dedicated cloud service;

FIG. 2 is a system configuration diagram of a resource adjustment system according to a present embodiment;

FIG. 3 is a schematic diagram of the resource adjustment system according to the present embodiment;

FIG. 4 is a functional block diagram of a physical server according to the present embodiment;

FIG. 5 is a schematic diagram illustrating an example of the screen display of a display unit in the present embodiment;

FIG. 6 is a functional configuration diagram of the resource adjustment device according to the present embodiment;

FIG. 7 is a sequence diagram of a resource adjustment method according to the present embodiment (No. 1);

FIG. 8 is a sequence diagram of the resource adjustment method according to the present embodiment (No. 2);

FIG. 9 is a sequence diagram of the resource adjustment method according to the present embodiment (No. 3);

FIG. 10 is a flowchart of a method for calculating an average value and a maximum value of a memory usage of each virtual machine in the present embodiment;

FIG. 11 is a flowchart of a reduction process in the present embodiment (No. 1);

FIG. 12 is a flowchart of the reduction process in the present embodiment (No. 2);

FIG. 13 is a sequence diagram of a method for returning a reserved memory size of a virtual machine in operation to an initial value in the present embodiment (No. 1);

FIG. 14 is a sequence diagram of the method for returning the reserved memory size of the virtual machine in operation to the initial value in the present embodiment (No. 2);

FIG. 15 is a schematic diagram illustrating an identification process for identifying the virtual machine in operation in which memory usage is likely to reach the reserved memory size in the present embodiment;

FIG. 16 is a flowchart illustrating the identification process for identifying the virtual machine in operation in which memory usage is likely to reach the reserved memory size in the present embodiment; and

FIG. 17 is a hardware configuration diagram of each of the physical server and the resource adjustment device according to the present embodiment.

### DESCRIPTION OF EMBODIMENTS

Prior to the description of the present embodiment, matters studied by an inventor will be described.

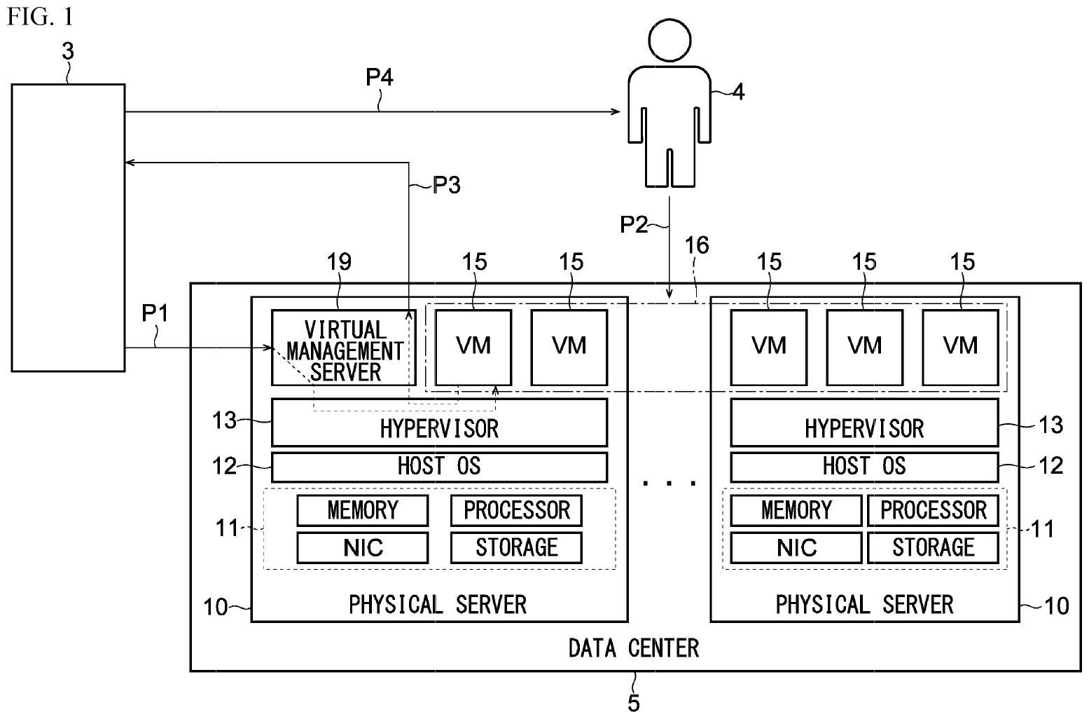

FIG. 1 is a schematic diagram of a dedicated cloud service.

In the dedicated cloud service, a service provider 3 constructs a system 16 for providing the cloud service in a data center 5 owned by a user 4.

The data center 5 is a computer room that houses a plurality of physical servers 10. Each physical server 10 has a physical resource 11 such as a memory, a processor, a NIC (Network Interface Card), and a storage. A host OS 12 is executed on the resource 11, and a hypervisor 13 is executed on the host OS 12. The physical server 10 may execute the hypervisor 13 on the resource 11.

The hypervisor 13 is a program for realizing a virtual environment on each physical server 10. In this example, the physical server 10 starts a plurality of virtual machines 15 on the hypervisor 13.

Each of the virtual machines 15 is a virtual computer that executes a guest OS and an application program, and the system 16 is constructed by these virtual machines 15. The system 16 is a system for providing the service according to the request of the user 4, and is constructed and operated by the service provider 3.

Further, one of the plurality of physical servers 10 executes a virtual management server 19 for managing each of the plurality of virtual machines 15. Just like the virtual machine 15, the virtual management server 19 is a virtual machine that runs on the hypervisor 13.

Next, a description will be given of the flow of processing during the operation of this dedicated cloud service.

First, the service provider 3 sets the parameters for the resource 11 for each virtual machine 15 via the virtual management server 19 (P1).

The parameters related to the memory in the resource 11 include an allocated memory size and a reserved memory size.

The allocated memory size is a maximum memory size that can be used by a single virtual machine 15. For example, when the allocated memory size is set to 4 GB, the maximum memory size that can be used by the virtual machine 15 is 4 GB.

On the other hand, the reserved memory size is a memory size that is guaranteed to be occupied by the single virtual machine 15. For example, the virtual machine 15 in which the reserved memory size is set to 2 GB can exclusively use the memory size of 2 GB without sharing the memory size with other virtual machines 15.

The reserved memory size can be set, for example, when the virtual machine 15 always secures a desired memory size even when the memory of the entire physical server 10 becomes insufficient. The reserved memory size can also be set to prevent the performance of the virtual machine 15 from deteriorating due to paging and swap processes of the host OS 12, and to ensure stable operation of the virtual machine 15.

Next, the user 4 uses the system 16 (P2).

Subsequently, the service provider 3 acquires the reserved memory size set for each virtual machine 15 in the system 16 via the virtual management server 19 (P3).

Next, the service provider 3 charges the user 4 for the usage fee of the system 16 according to the acquired reserved memory size (P4). For example, the service provider 3 charges the user 4 for the usage fee by meter rate charging in which the usage fee increases as the reserved memory size increases.

This completes the basic process during operation of the dedicated cloud service.

In this example, since the user 4 is charged by the meter rate charging according to the reserved memory size as described above, it is considered that the charge system is reasonable in that the charge is paid only for an amount used by the user.

However, the reserved memory size is the memory size occupied by the virtual machine 15 as described above, and even if there is an unused area in the reserved memory size, the unused area cannot be used by another virtual machine 15. Therefore, when the service provider 3 sets the reserved memory size of a certain virtual machine 15 to be too large, a wasted memory area that cannot be used by any of the plurality of virtual machines 15 is generated, and the memory usage efficiency is lowered.

In addition, from the point of view of the user 4, such an unused memory area is also a charging object. Therefore, it is necessary to pay the charge for the resource that is not actually used, and the charge system does not necessarily satisfy the user 4.

Moreover, from the point of view of the service provider 3, there is a risk of making an excessive investment such as adding memories to the physical server 10 in order to prevent the reserved memory size from becoming insufficient.

Hereinafter, a description will be given of the present embodiment capable of reducing the resource such as the memory occupied by the virtual machine.

### Present Embodiment

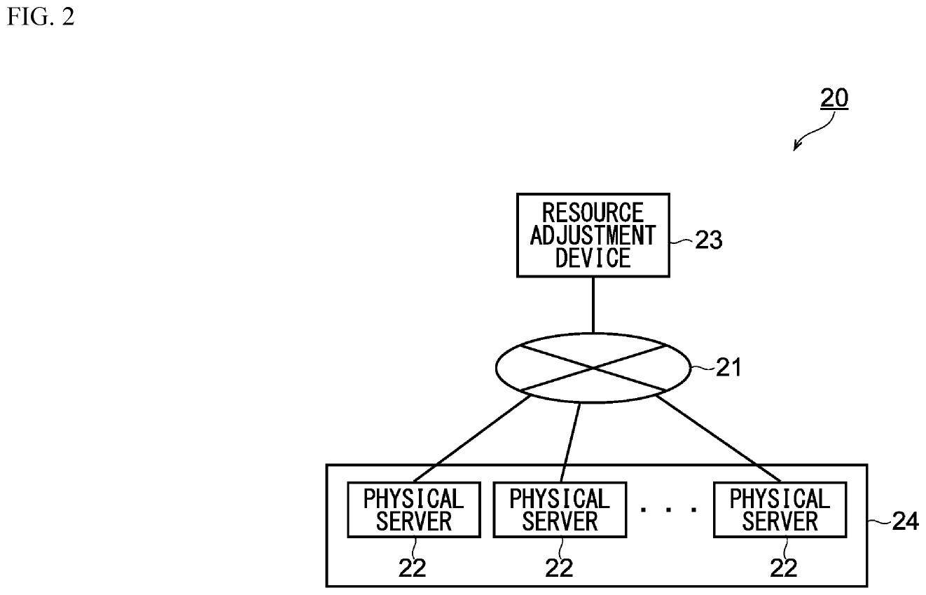

FIG. 2 is a system configuration diagram of a resource adjustment system according to the present embodiment.

A resource adjustment system 20 is a system that adjusts an amount of the resource of the virtual machine in the dedicated cloud service. In this example, the resource adjustment system 20 has a plurality of physical servers 22 and a resource adjustment device 23 that are connected to each other via a network 21 such as a LAN (Local Area Network).

Each physical server 22 is a computer for starting the virtual machine, and is housed in a data center 24 owned by a user of the dedicated cloud service.

The resource adjustment device 23 is a computer such as a physical server or a PC (Personal Computer) that adjusts the amount of the resource such as the amount of the memory used in the virtual machine.

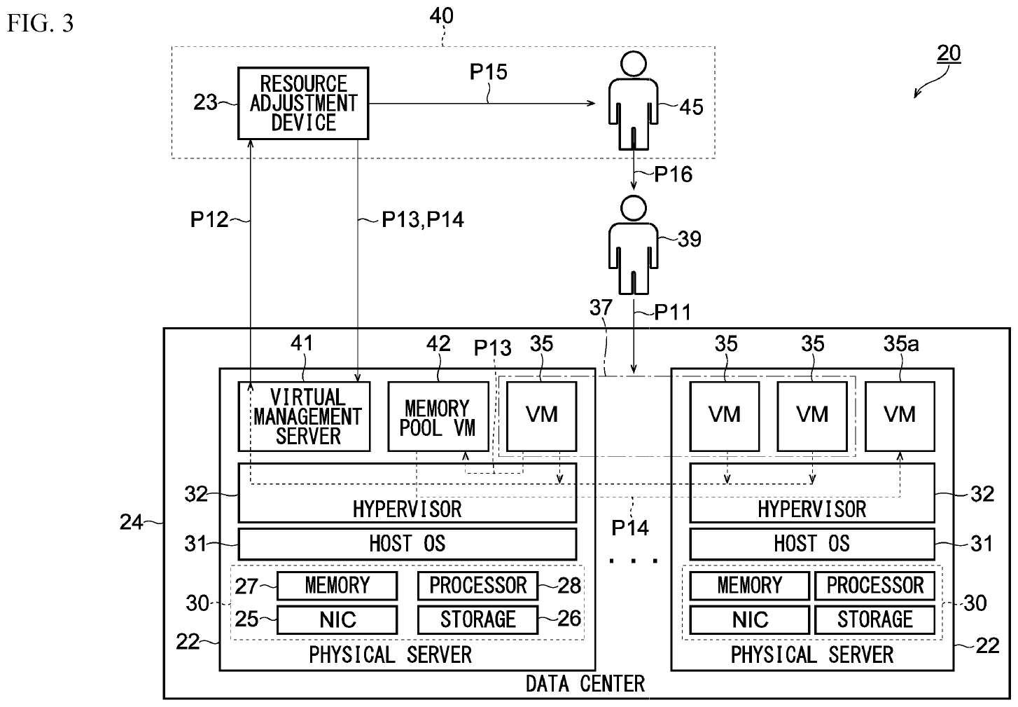

FIG. 3 is a schematic diagram of the resource adjustment system 20 according to the present embodiment.

As illustrated in FIG. 3, each physical server 22 has a physical resource 30 such as a NIC 25, a storage 26, a memory 27 and a processor 28. Then, the physical server 22 executes a host OS 31 and a hypervisor 32 on the resource 30.

The hypervisor 32 is a virtualization program executed on the host OS 31. In this example, the physical server 22 executes a plurality of virtual machines 35 on the hypervisor 32. Here, each of the virtual machines 35 is an example of a first virtual machine.

Each virtual machine 35 is a virtual computer to which a part of each of the NIC 25, the storage 26, the memory 27 and the processor 28 is allocated, and executes the guest OS and the application program. Then, a system 37 for providing the service according to the request of a user 39 is constructed by the plurality of virtual machines 35. The system 37 is constructed and operated by a service provider 40.

One of the plurality of physical servers 22 executes a virtual management server 41 and a memory pool VM 42.

The virtual management server 41 is a virtual machine that monitors the memory usage of each virtual machine 35 and sets or changes parameters for the resource 30 used by each virtual machine 35. Such parameters include the allocated memory size and the reserved memory size used in the above-mentioned description of FIG. 1.

The memory pool VM 42 is an example of a third virtual machine, and is a virtual machine for storing a memory capacity to be allocated to each virtual machine 35.

Next, a description will be given of the flow of processing in the resource adjustment system 20.

Here, the description will be given of an example of starting a new virtual machine 35a when the allocated memory size and the reserved memory size of each virtual machine 35 are already set by the service provider 40. The new virtual machine 35a may be inside the system 37, but here, it is assumed that the new virtual machine 35a is newly started outside the system 37. The new virtual machine 35a is an example of a second virtual machine.

In this case, the user 39 first starts to use the system 37 (P11).

Next, the virtual management server 41 acquires the actual memory usage of each virtual machine 35 in operation and notifies the resource adjustment device 23 of the actual memory usage (P12).

Next, the resource adjustment device 23 sets a ranking for each virtual machine 35 according to the actual memory usage, and moves, to the memory pool VM 42, the unused area among the reserved memory size of the virtual machine 35 having the highest ranking (P13). As an example, the resource adjustment device 23 sets the ranking to each virtual machine 35 in a descending order of a difference between the reserved memory size and an average value of the actual memory usage in a certain period.

Next, the resource adjustment device 23 allocates the reserved memory size of the memory pool VM42 to the new virtual machine 35a before starting, and starts the new virtual machine 35a (P14).

Next, the resource adjustment device 23 calculates the usage charge of the system 37 according to the reserved memory size of the virtual machine 35 in operation, and notifies a person in charge 45 of the service provider 40 of the usage charge (P15).

Then, the person in charge 45 notifies the user 39 of the usage charge of the system 37 (P16).

This completes the basic processing in the resource adjustment system 20.

According to this processing, the unused area in the reserved memory size of the virtual machine 35 is allocated to the new virtual machine 35a, thereby reducing the reserved memory size occupied by the virtual machine 35. Therefore, the system 37 can effectively utilize the hardware resource 30 including the memory 27, and can suppress the wasteful use of the resource 30.

Moreover, since the reserved memory size of the virtual machine 35 is reduced in this way, the usage charge of the system 37 becomes cheaper, and the service provider 40 refrains from adding the memory 27.

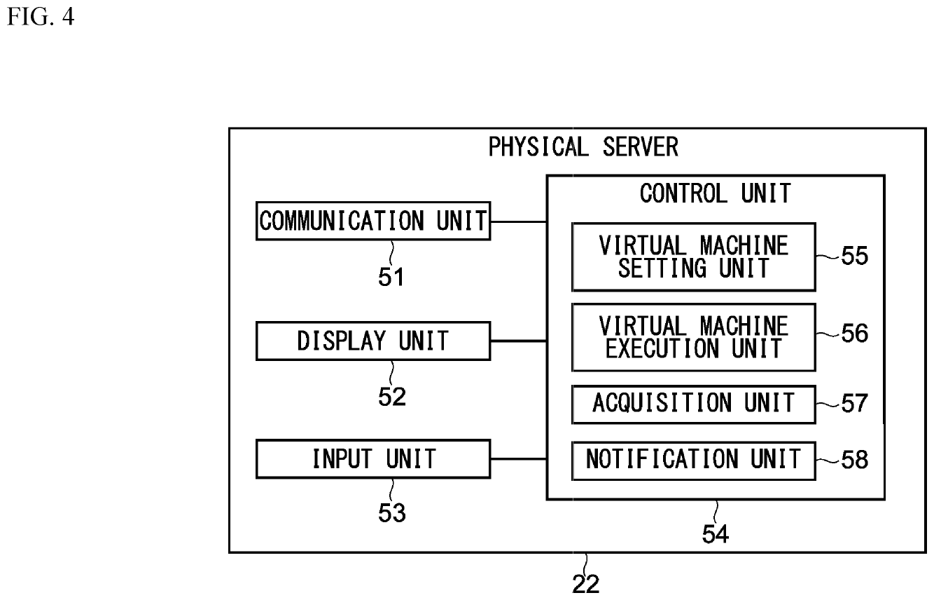

Next, a description will be given of the functional configuration of the physical server 22. FIG. 4 is a functional block diagram of the physical server 22. As illustrated in FIG. 4, the physical server 22 includes a communication unit 51, a display unit 52, an input unit 53 and a control unit 54.

The communication unit 51 is an interface for connecting the physical server 22 to the network 21. The display unit 52 is a display device such as a liquid crystal display for displaying a screen prompting an administrator to input the parameters for the resource of each virtual machine 35.

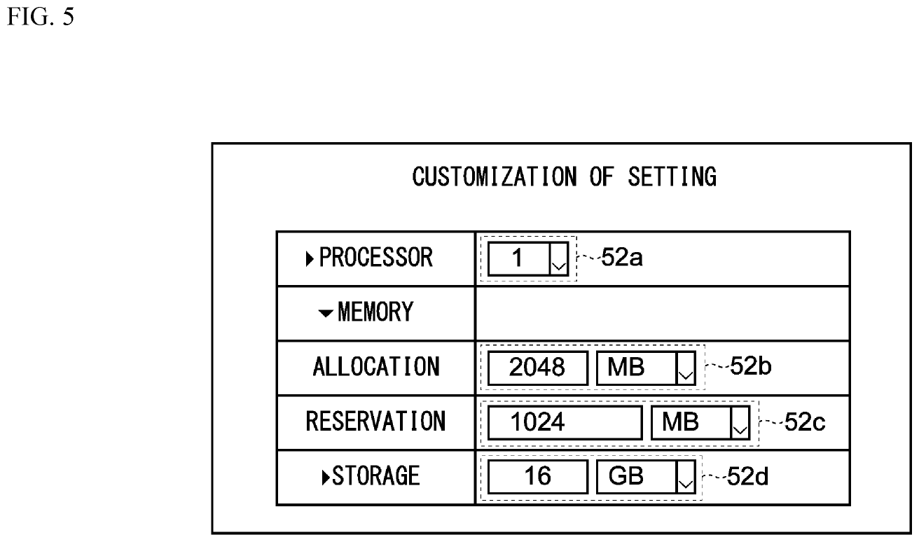

FIG. 5 is a schematic diagram illustrating an example of the screen display of the display unit 52. In this example, a screen prompting input of the respective parameters of a number of processors 52a of the virtual machine 35, an allocated memory size 52b, a reserved memory size 52c, and a disk size 52d of the storage is displayed on the display unit 52 as illustrated in FIG. 5.

Referring again to FIG. 4, the input unit 53 is an input device such as a keyboard or a mouse for the administrator to input each parameter displayed on the display unit 52 to the physical server 22.

The control unit 54 is a processing unit that controls each unit of the physical server 22, and includes a virtual machine setting unit 55, a virtual machine execution unit 56, an acquisition unit 57, and a notification unit 58.

The virtual machine setting unit 55 is a processing unit that sets the amount of the resource of each virtual machine 35 to each parameter input from the input unit 53 by the administrator. Further, the virtual machine execution unit 56 is a processing unit that, after the virtual machine setting unit 55 sets the amount of the resource, executes each virtual machine 35 to which the resource is allocated.

Then, the acquisition unit 57 acquires the amount of the resource used by each virtual machine 35 in operation. The amount of the resource is the memory usage, for example.

The notification unit 58 is a processing unit that notifies the resource adjustment device 23 of the amount of the resource acquired by the acquisition unit 57.

In the present embodiment, a function of the virtual management server 41 (see FIG. 3) is realized by the virtual machine setting unit 55, the virtual machine execution unit 56, the acquisition unit 57 and the notification unit 58.

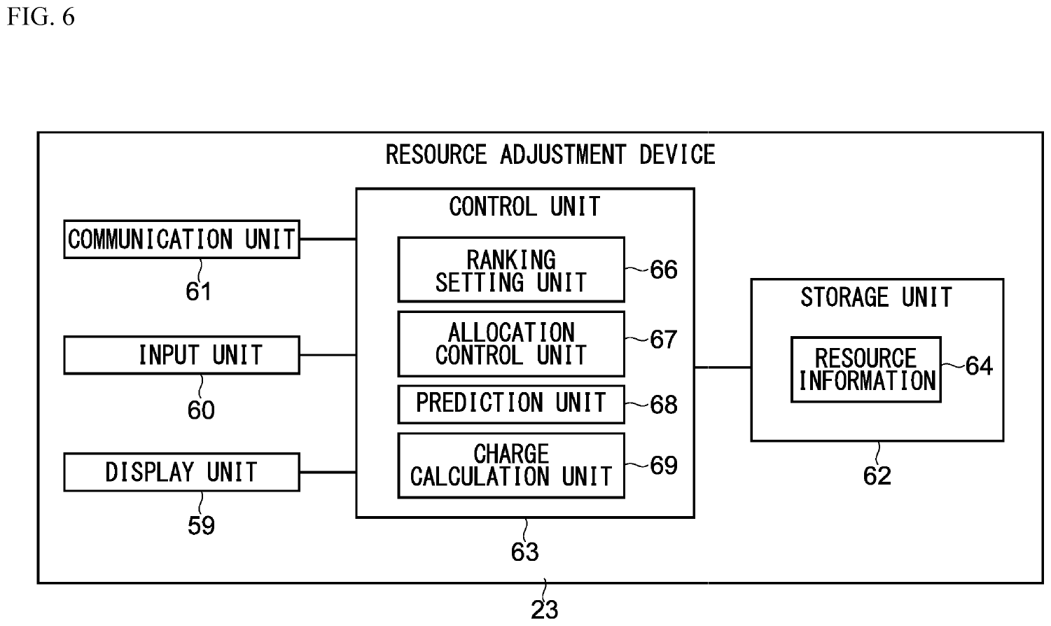

Next, a description will be given of the functional configuration of the resource adjustment device 23. FIG. 6 is a functional configuration diagram of the resource adjustment device 23. As illustrated in FIG. 6, the resource adjustment device 23 includes a display unit 59, an input unit 60, a communication unit 61, a storage unit 62, and a control unit 63.

The display unit 59 is a display device such as a liquid crystal display that displays various information to the administrator. For example, the display unit 59 displays a message instructing the addition of the memory 27 when the memory 27 of the physical server 22 is insufficient.

Further, the input unit 60 is an input device such as a keyboard or a mouse for the administrator to input various information to the resource adjustment device 23.

The communication unit 61 is an interface for connecting the resource adjustment device 23 to the network 21 (see FIG. 2). The storage unit 62 stores resource information 64 in which the amount of the resource used by each virtual machine 35 in operation is stored. The amount of the resource is the actual memory usage of each virtual machine 35, for example.

The control unit 63 is a processing unit that controls each unit of the resource adjustment device 23, and includes a ranking setting unit 66, an allocation control unit 67, a prediction unit 68, and a charge calculation unit 69.

The ranking setting unit 66 is a processing unit that sets the ranking to each of the plurality of virtual machines 35 according to the amount of the resource used by each of the plurality of virtual machines 35 in operation. A method of setting the ranking will be described later.

The allocation control unit 67 is a processing unit that allocates the resource of the virtual machine 35 having the highest ranking to the memory pool VM 42 by controlling the virtual machine setting unit 55 of the virtual management server 41. Further, the allocation control unit 67 allocates the resource allocated to the memory pool VM42 in this way to the new virtual machine 35a before starting.

The prediction unit 68 is a processing unit that predicts whether the memory usage actually used by another virtual machine 35 reaches the reserved memory size of the virtual machine 35 after the allocation control unit 67 allocates the resource to the new virtual machine 35a.

The charge calculation unit 69 is a processing unit that calculates the usage charge of the system 37 according to the reserved memory size of each virtual machine 35 after the allocation control unit 67 allocates the resource to the new virtual machine 35a. As an example, the charge calculation unit 69 calculates an average value of the memory usage within a predetermined period for each virtual machine 35, and calculates a value obtained by multiplying the average value by a unit price of the charge. Then, the charge calculation unit 69 calculates a sum of all the values of the virtual machines 35, and calculates the sum as the usage charge of the system 37. Here, the predetermined period for taking the average value of the memory usage is one month, one day, or one hour, for example.

Next, a description will be given of a resource adjustment method according to the present embodiment.

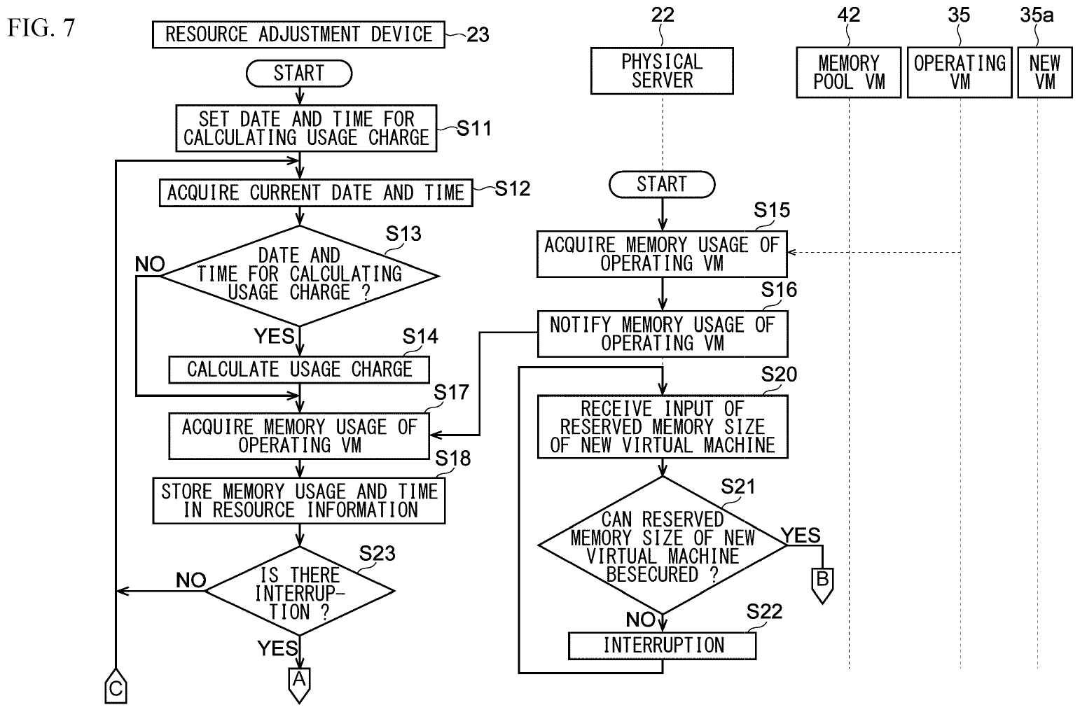

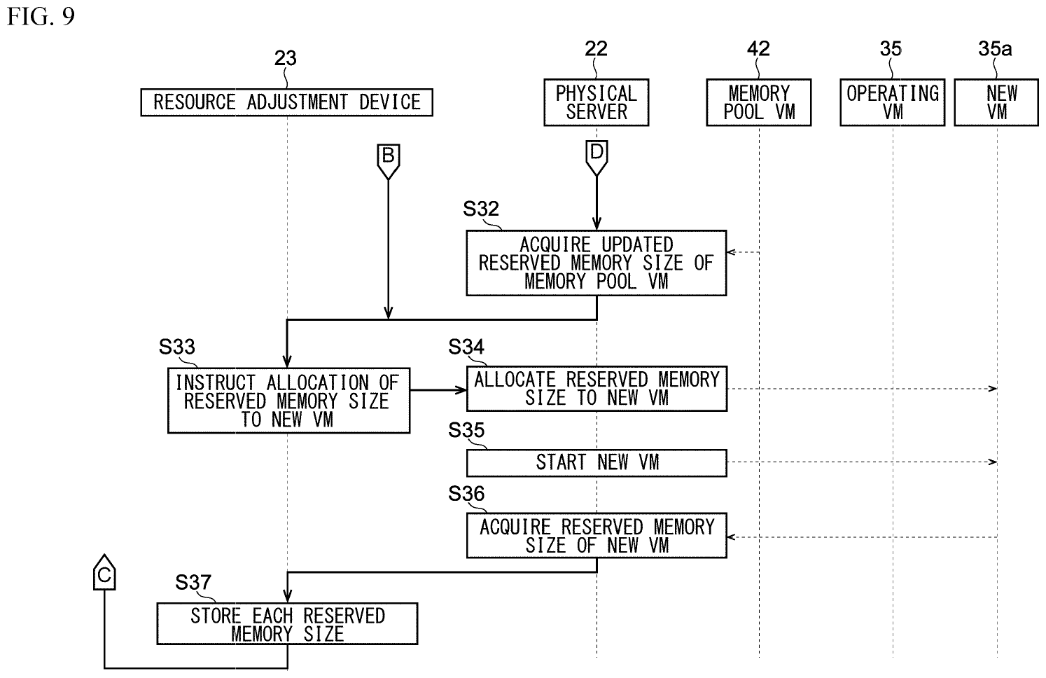

FIGS. 7 to 9 are sequence diagrams of the resource adjustment method according to the present embodiment.

First, the charge calculation unit 69 sets a date and time for calculating the usage charge (step S11), and acquires a current date and time (step S12).

Next, the charge calculation unit 69 determines whether the current date and time is the date and time for calculating the usage charge (step S13).

Here, when the current date and time is the date and time for calculating the usage charge (step S13: YES), the process proceeds to step S14, and the charge calculation unit 69 calculates the usage charge.

In parallel with steps S11 to S14, the acquisition unit 57 of the virtual management server 41 acquires the memory usage of each virtual machine 35 in operation (step S15). Then, the notification unit 58 of the virtual management server 41 notifies the resource adjustment device 23 of the memory usage (step S16).

The resource adjustment device 23 acquires the memory usage from the notification unit 58 after the calculation of the usage charge in step S14 is completed (step SI7). Even when the current date and time is not the date and time for calculating the usage charge (step S13: NO), the resource adjustment device 23 acquires the memory usage in step S17.

Next, the control unit 63 associates the memory usage of each virtual machine 35 in operation with a time when the memory usage is acquired, and stores the memory usage and the time in the resource information 64 (step S18). An initial value of the reserved memory size for each virtual machine 35 in operation is also stored in advance in the resource information 64. The initial value is a value input to the reserved memory size 52c in the screen of FIG. 5 by the administrator.

Further, in parallel with step S18 described above, the input unit 53 of the physical server 22 receives the input of the reserved memory size of the new virtual machine 35a (step S20).

Next, the virtual machine setting unit 55 of the physical server 22 determines whether the reserved memory size of the new virtual machine 35a can be secured in a free area of the memory 27 (step S21). When it is determined that the reserved memory size cannot be secured, the virtual machine setting unit 55 performs an interruption on the resource adjustment device 23 (step S22), and the process returns to step S20 again.

The control unit 63 of the resource adjustment device 23 determines whether there is the interruption from the virtual machine setting unit 55 (step S23), and the process returns to step S12 when there is not the interruption.

On the other hand, when there is the interruption (step S23: YES), the process proceeds to step S25.

In step S25, the allocation control unit 67 calculates an amount of reduction in the reserved memory size of each virtual machine 35 in order to reduce the reserved memory size of the virtual machine 35 in operation. Then, the allocation control unit 67 performs a reduction process that instructs the virtual machine setting unit 55 of the physical server 22 to reduce the reserved memory size of each virtual machine 35 by the calculated reduction amount. The details of the reduction process will be described later.

Subsequently, the virtual machine setting unit 55 receiving the instruction reduces the reserved memory size of each virtual machine 35 (step S26).

Then, the virtual machine setting unit 55 allocates a reduced portion in the reserved memory size of each virtual machine 35 to the reserved memory size of the memory pool VM42 (step S27).

Next, the allocation control unit 67 determines whether the reserved memory size of the new virtual machine 35a can be secured in the free area of the memory 27 by reducing the reserved memory size of each virtual machine 35 in operation as described above (step S28).

Here, when it is determined that the reserved memory size cannot be secured, the process proceeds to step S29.

In step S29, the allocation control unit 67 determines whether the reserved memory size of the memory pool VM42 is sufficient. As an example, the allocation control unit 67 determines whether the reserved memory size of the memory pool VM42 is larger than the reserved memory size of the new virtual machine 35a. Instead, it may be determined whether the reserved memory size of the memory pool VM 42 is larger than the sum of the reserved memory size of each virtual machine 35 reduced in step S25 and the reserved memory size of the new virtual machine 35a.

Here, when it is determined that the reserved memory size of the memory pool VM42 is not sufficient, the process proceeds to step S30. In this case, the reserved memory size of the new virtual machine 35a cannot be covered by the memory pool VM42. Therefore, in step S30, the display unit 59 displays the message instructing the administrator to add the memory 27 of the physical server 22.

On the other hand, when it is determined that the reserved memory size of the memory pool VM42 is sufficient (step S29: YES), the process proceeds to step S31.

In step S31, the virtual machine setting unit 55 of the physical server 22 reduces the reserved memory size of the memory pool VM42. As an example, the virtual machine setting unit 55 calculates the difference between the reserved memory size of the new virtual machine 35a and the sum of amounts of reduction in the reserved memory size of each virtual machine 35 calculated in step S25, as an insufficient amount of the memory size. Then, the virtual machine setting unit 55 reduces the reserved memory size of the memory pool VM 42 by the insufficient amount.

Next, the acquisition unit 57 of the physical server 22 acquires the updated reserved memory size of the memory pool VM 42 from the memory pool VM 42 (step S32).

Next, the allocation control unit 67 of the resource adjustment device 23 instructs the physical server 22 to allocate the reserved memory size of the memory pool VM42 to the reserved memory size of the new virtual machine 35a (step S33).

The reserved memory size of the memory pool VM42 allocated to the new virtual machine 35a corresponds to the reduction amount of the reserved memory size of the memory pool VM42 in each of steps S26 and S31.

When it is determined in step S28 that the reserved memory size of the new virtual machine 35a can be secured, steps S32 and S33 are performed without performing steps S29 to S31. In this case, the allocation control unit 67 instructs the physical server 22 to allocate the reduction amount of the reserved memory size of the memory pool VM42 in step S31 to the reserved memory size of the new virtual machine 35a.

When it is also determined in step S21 that the reserved memory size of the new virtual machine 35a can be secured in the free area of the memory 27, step S33 is executed. In this case, the allocation control unit 67 instructs the physical server 22 to allocate the free area of the memory 27 to the reserved memory size of the new virtual machine 35a.

Next, the virtual machine setting unit 55 of the physical server 22 allocates the reduction amount of the reserved memory size of the memory pool VM42 to the reserved memory size of the new virtual machine 35a according to the instruction of step S33 (step S34).

Next, the virtual machine execution unit 56 of the physical server 22 starts the new virtual machine 35a (step S35).

Next, the acquisition unit 57 of the physical server 22 acquires the reserved memory size of the new virtual machine 35a (step S36).

Then, the control unit 63 of the resource adjustment device 23 associates the reserved memory size acquired in each of steps S32 and S36 with the acquired date and time, and stores them in the storage unit 62 (step S37). After that, the process returns to step S12.

This completes the basic processing of the resource adjustment method according to the present embodiment.

Next, a description will be given of the reduction process of the reserved memory size of each virtual machine 35 in step S25.

The reduction process uses the average value of the memory usage of each virtual machine 35 in a certain period and the maximum value of the memory usage of each virtual machine 35 in the certain period. Therefore, a description will be first given of a method for calculating the average value and the maximum value of the memory usage of each virtual machine 35.

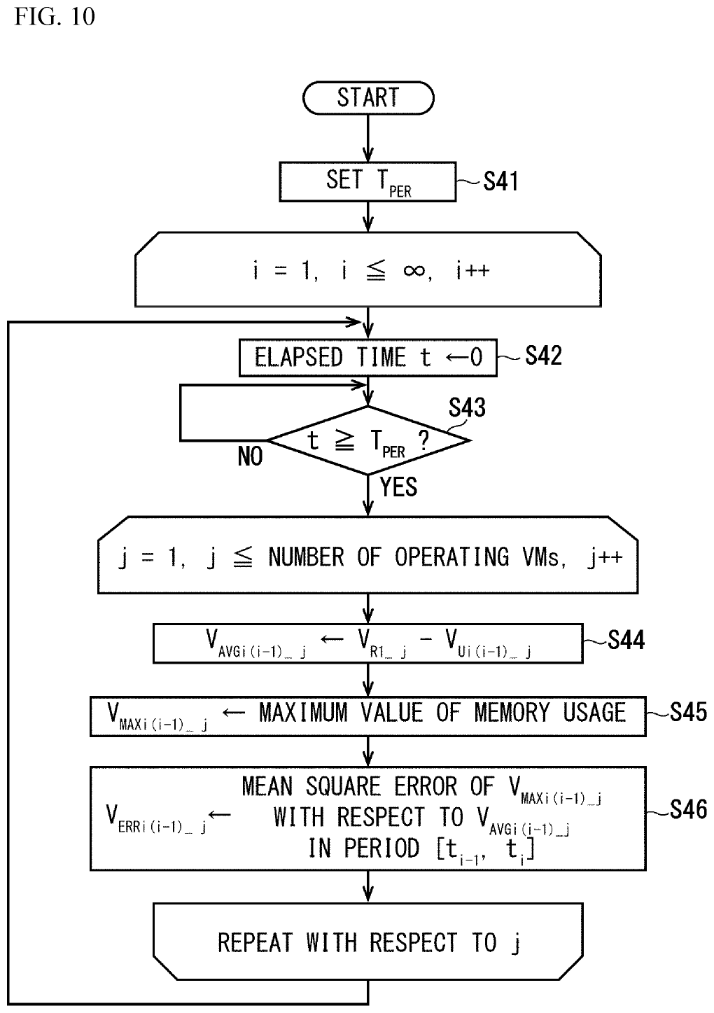

FIG. 10 is a flowchart of the method for calculating the average value and the maximum value of the memory usage of each virtual machine 35.

First, the ranking setting unit 66 sets a time period T_{PER} for setting the ranking (step S41). The time period T_{PER} is not particularly limited, but can be set to 3600 seconds, for example.

After S41, the following steps S42 to S46 are repeated for each time (i=1, 2, . . . ).

First, the ranking setting unit 66 resets the elapsed time t to 0 (step S42), and then starts counting up the elapsed time t.

Next, the ranking setting unit 66 determines whether the elapsed time t is equal to or more than the time period T_{PER} (step S43). When it is determined that the elapsed time t is not equal to or more than the time period T_{PER}, step S43 is repeated.

On the other hand, when it is determined that the elapsed time t is equal to or more than the time period T_{PER} (step S43: YES), the process proceeds to step S44.

In step S44, the ranking setting unit 66 stores a difference between a current reserved memory size V_{R1_j} of a j-th virtual machine 35 and an average value of memory usages V_{Ui(i-1)_j} of the j-th virtual machine 35 in a period [tᵢ₁, tᵢ] into a variable V_{AVGi(i-1)_j} by referring to the resource information 64. A value of the variable V_{AVGi(i-1)_j} is the average value of the memory sizes not used by the j-th virtual machine 35 in the predetermined period [tᵢ₋₁, tᵢ].

Next, the ranking setting unit 66 acquires the maximum value of the memory usage of the j-th virtual machine 35 in the period [tᵢ₋₁, tᵢ] by referring to the resource information 64, and stores it in a variable V_{MAXi(i-1)_j} (Step S45).

Next, the ranking setting unit 66 calculates a mean square error of the variable V_{MAXi(i-1)_j} with respect to the variable V_{AVGi(i-1)_j} in the period [tᵢ₋₁, tᵢ], and calculates it in the variable V_{ERRi(i-1)_j} (step S46). A value of the variable V_{ERRi(i-1)_j} is a variation in the memory size used by the j-th virtual machine 35 in the predetermined period [tᵢ₋₁, tᵢ].

After that, steps S44 to S46 are performed on all the virtual machines 35 in operation by changing the value of the variable j. Then, the process returns to step S42 again, and steps S42 to S46 are repeated in the next period.

Thereby, the ranking setting unit 66 acquires the respective values of the variables V_{MAXi(i-1)_j} and V_{ERRi(i-1)_j} when the value of the variable i becomes 1, 2, 3, . . . .

The reduction process in step S25 is executed as follows by using the respective values of the variables V_{AVGi(i-1)_j} and V_{ERRi(i-1)_j}.

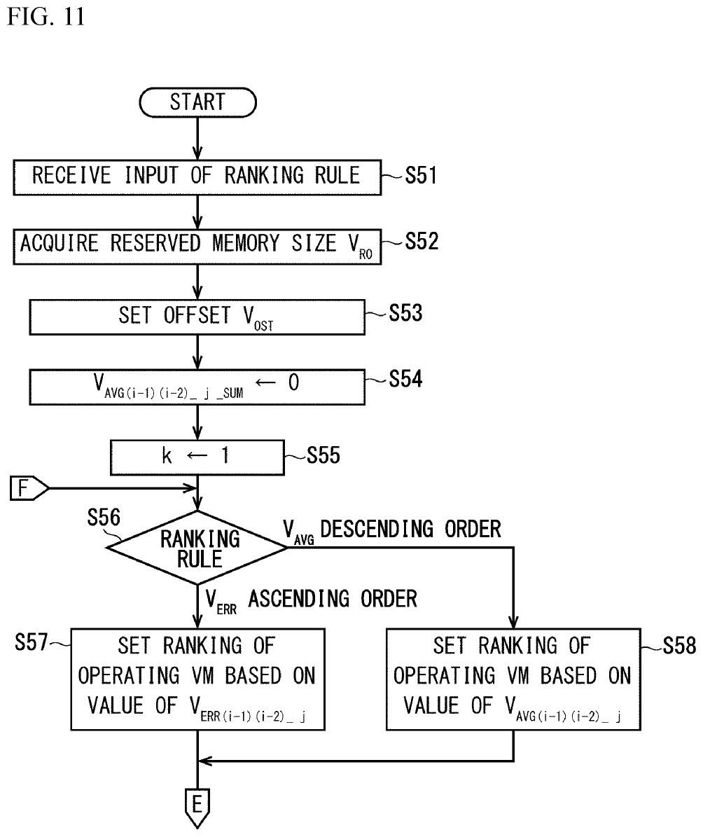

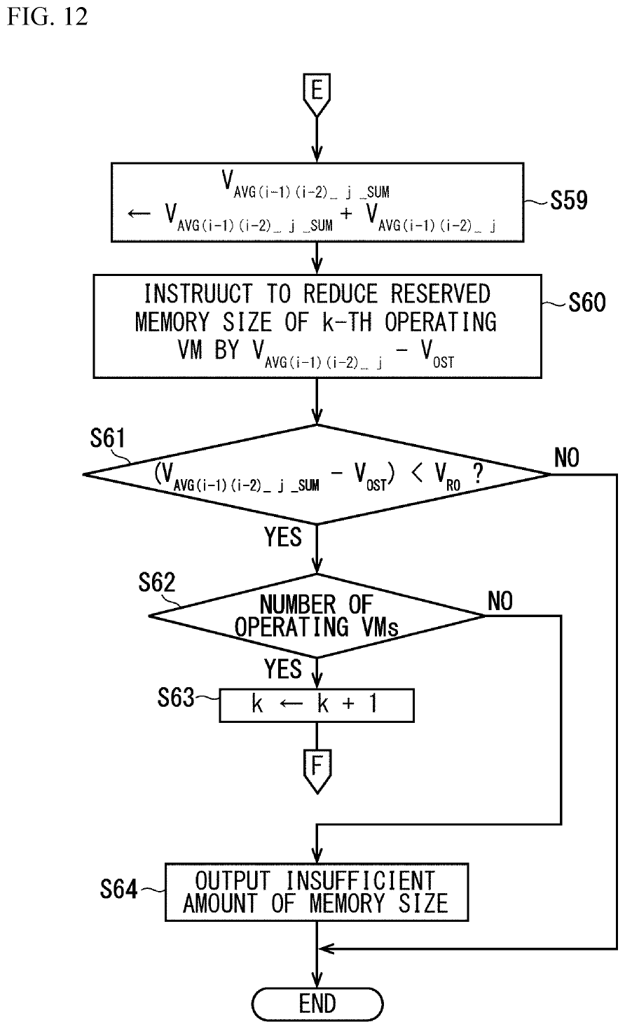

FIGS. 11 and 12 are flowcharts of the reduction process in step S25.

First, the input unit 60 receives the input of a ranking rule (step S51). The rule includes a rule for setting the ranking of each virtual machine 35 in a descending order of the average value of unused memory size, or a rule for setting the ranking of each virtual machine 35 in an ascending order of the mean square error of the memory usage.

Next, the ranking setting unit 66 acquires a reserved memory size V_{R0} of the new virtual machine 35a (step S52).

Next, the ranking setting unit 66 sets an offset V_{OST} with respect to the reserved memory size of each virtual machine 35 in operation (step S53). The offset V_{OST} is a memory size for allowing a margin in the reserved memory size of each virtual machine 35 when the reserved memory size of each virtual machine 35 is reduced and the reduction amount is allocated to the new virtual machine 35a.

Next, the ranking setting unit 66 initializes the value of a variable V_{AVG(i-1)(i-2)_j_SUM} to 0 (step S54). The variable V_{AVG(i-1)(i-2)_j_SUM} sum is the sum of the average values of the memory usage of all the virtual machines 35 that allocate the reserved memory size to the new virtual machine 35a in the period [tᵢ₋₂, tᵢ₋₁].

Next, the ranking setting unit 66 initializes a value of a variable k indicating the ranking of each virtual machine 35 to 1 (step S55).

Next, the ranking setting unit 66 determines whether the ranking rule is in the descending order of the average value of the unused memory sizes (hereinafter referred to as “V_{AVG} descending order”) or in the ascending order of the mean square error of the memory usage (hereinafter referred to as “V_{ERR} ascending order”) (step S56).

When it is determined in step S56 that the ranking rule is the V_{ERR} ascending order, the process proceeds to step S57.

In step S57, the ranking setting unit 66 sets the virtual machine 35 having a k-th smallest value of the variable V_{ERR(i-1)(i-2)_j} to a k-th ranking, and identifies the variable V_{AVG(i-1)(i-2)_j of the virtual machine 35 of the k-th ranking. Hereinafter, it is assumed that the virtual machine 35 having the k-th ranking is associated with a predetermined serial number j regardless of the ranking.}

On the other hand, when it is determined in step S56 that the ranking rule is the V_{AVG} descending order, the process proceeds to step S58.

In step S58, the ranking setting unit 66 sets the virtual machine 35 having a k-th largest value of the variable V_{AVG(i-1)(i-2)_j} to the k-th ranking, and identifies the variable V_{AVG(i-1)(i-2)_j} of the virtual machine 35 of the k-th ranking.

Next, the ranking setting unit 66 increments the value of the variable V_{AVG(i-1)(i-2)_j_SUM} by the value of the variable V_{AVG(i-1)(i-2)_j} (step S59).

Next, the allocation control unit 67 calculates a value of V_{AVG(i-1)(i-2)_j}−V_{OST} as a reduction amount ΔV_{_j} of the reserved memory size of the j-th virtual machine 35 (step S60). Then, the allocation control unit 67 instructs the virtual machine setting unit 55 of the physical server 22 to reduce the reserved memory size of the j-th virtual machine 35 by the reduction amount ΔV_{_j}. Further, the allocation control unit 67 stores the reduced reserved memory size in the resource information 64.

Next, the allocation control unit 67 determines whether the value of V_{AVG(i-1)(i-2)_j_SUM}−V_{OST} is smaller than V_{R0} (step S61).

When the value of V_{AVG(i-1)(i-2)_j_SUM}−V_{OST} is not smaller than V_{R0}, this means that the reserved memory size V_{R0} of the new virtual machine 35a can be covered by the virtual machine 35 in operation. Therefore, in this case, the process completes.

On the other hand, when the value of V_{AVG(i-1)(i-2)_j_SUM}−V_{OST} is smaller than V_{R0} (step S6: YES), the reserved memory size VR0 of the new virtual machine 35a cannot be covered by the virtual machine 35 in operation at this point, so the process proceeds to step S62.

In step S62, the allocation control unit 67 determines whether the value of the variable k is smaller than the total number of virtual machines 35 in operation.

Here, when the value of the variable k is smaller than the total number of virtual machines 35 in operation, the process proceeds to step S63 and the allocation control unit 67 increments the value of the variable k by 1, and then the process returns to step S56.

On the other hand, when the value of the variable k is not smaller than the total number of virtual machines 35 in operation (step S62: NO), the process proceeds to step S64.

This case means that the reserved memory size of the new virtual machine 35a is insufficient although the reserved memory sizes of all the virtual machines 35 are already allocated to the new virtual machine 35a.

Therefore, in step S64, the allocation control unit 67 calculates a value of V_{R0}−(V_{AVG(i-1)(i-2)_j_SUM}−V_{OST}) as an insufficient amount of the reserved memory size of the new virtual machine 35a, and the display unit 59 displays the insufficient amount.

This completes the basic processing in the reduction process of the reserved memory size in step S25.

According to such a process, in step S60, the allocation control unit 67 performs a process of reducing the reserved memory size in order from the virtual machine 35 having the highest ranking in which the value of k is 1. Then, the allocation control unit 67 controls to allocate the reserved memory size for the reduction amount in this way to the new virtual machine 35a via the memory pool VM42 (steps S27 and S31).

As a result, the usage charge of the system 37 can be reduced, and the wasteful investment of adding the memory 27 can be avoided.

Further, when the “V_{AVG} descending order” is selected in step S56, the reserved memory size is preferentially reduced from the virtual machine 35 having the margin in the reserved memory size and having the highest ranking. Therefore, the reserved memory size of the virtual machine 35 having a lower ranking is not forcibly reduced, and the margin of the reserved memory size of the virtual machine 35 can be prevented from being run out, which allows the system 37 to operate stably.

When the “VERR ascending order” is selected in step S57, the reserved memory size is preferentially reduced from the virtual machine 35 having less time variation in the memory size in use. Therefore, a possibility is reduced that the memory usage exceeds the reserved memory size after the reserved memory size is reduced, which allows the system 37 to operate stably.

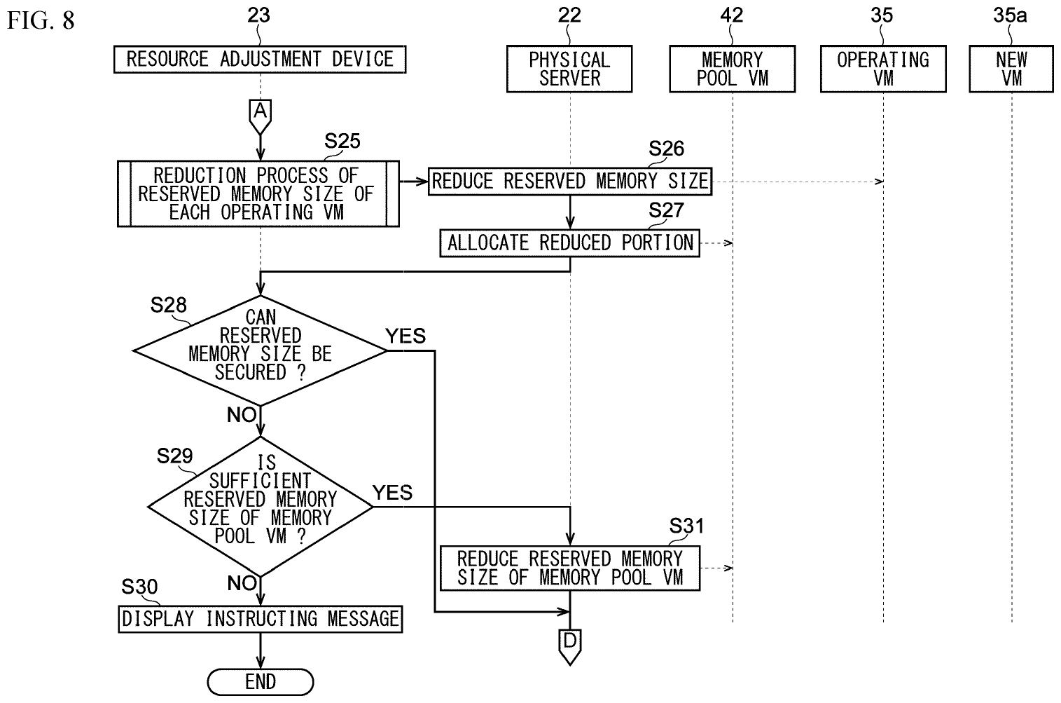

By the way, after the reserved memory size of the virtual machine 35 is reduced in step S26 (see FIG. 8), the actual memory usage of the virtual machine 35 might increase and reach the reserved memory size. In this case, it is preferable to return the reserved memory size of the virtual machine 35 to the initial value and prevent the actual memory usage from exceeding the reserved memory size.

Next, a description will be given of a method for returning the reserved memory size of the virtual machine 35 in operation to the initial value in this way.

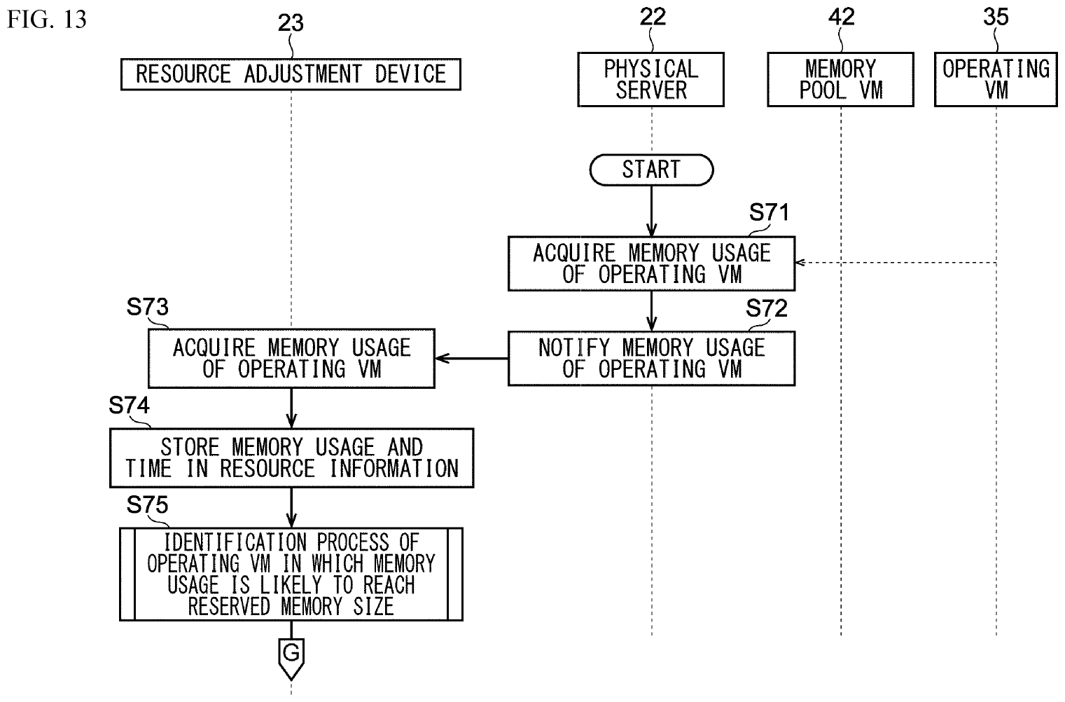

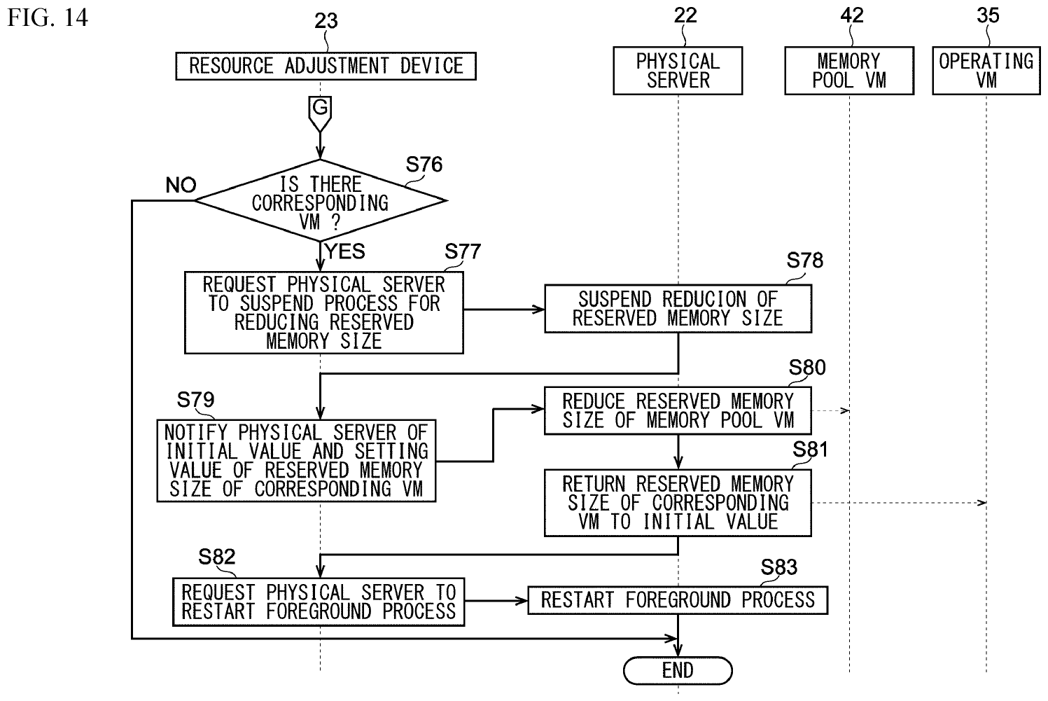

FIGS. 13 and 14 are sequence diagrams of a method for returning the reserved memory size of the virtual machine 35 in operation to the initial value.

First, the acquisition unit 57 of the physical server 22 acquires the memory usage of each virtual machine 35 in operation (step S71), and notifies the resource adjustment device 23 of the acquired memory usage (step S72).

Next, the control unit 63 of the resource adjustment device 23 acquires the memory usage (step S73), and associates the memory usage and the acquired time with each other to store them in the resource information 64 (step S74).

Next, the prediction unit 68 performs an identification process for identifying the virtual machine 35 in operation in which the memory usage is likely to reach the reserved memory size (step S75). The details of the identification process will be described later.

Next, the prediction unit 68 determines whether there is the virtual machine 35 in operation in which the memory usage is likely to reach the reserved memory size (step S76). Here, when there is not the virtual machine 35, the process completes.

On the other hand, when there is the virtual machine 35 (step S76: YES), the process proceeds to step S77.

In step S77, the allocation control unit 67 requests the virtual machine setting unit 55 of the physical server 22 to suspend the process for reducing the reserved memory size in step S26.

Then, the virtual machine setting unit 55 that receives the request suspends the process for reducing the reserved memory size in step S26 (step S78).

Next, the allocation control unit 67 notifies the virtual machine setting unit 55 of the physical server 22 of an initial value and a setting value of the reserved memory size of the virtual machine 35 identified in step S75 by referring to the resource information 64 (step S79). The initial value is a value input to the reserved memory size 52c on the screen of FIG. 5 by the administrator. Then, the setting value is a reserved memory size which is reduced by the reduction amount calculated in step S25.

Next, the virtual machine setting unit 55 that receives this notification reduces the reserved memory size of the memory pool VM42 by a difference between the initial value and the setting value of the virtual machine 35 (step S80).

Further, the virtual machine setting unit 55 allocates a reduction amount in step S80 among the reserved memory of the memory pool VM42 to the corresponding virtual machine 35, thereby returning the reserved memory size of the virtual machine 35 to the initial value (step S81). This increases the reserved memory size of the virtual machine 35, and thus can prevent the actual memory usage of the virtual machine 35 from exceeding the reserved memory size.

Next, the control unit 63 of the resource adjustment device 23 requests the physical server 22 to restart a foreground process including steps S15 and S20 (step S82), and the physical server 22 restarts the foreground process (step S83).

This completes the basic process of the method for returning the reserved memory size of the virtual machine 35 in operation to the initial value.

Next, a description will be given of an identification process for identifying the virtual machine 35 in operation in which the memory usage in step S75 is likely to reach the reserved memory size.

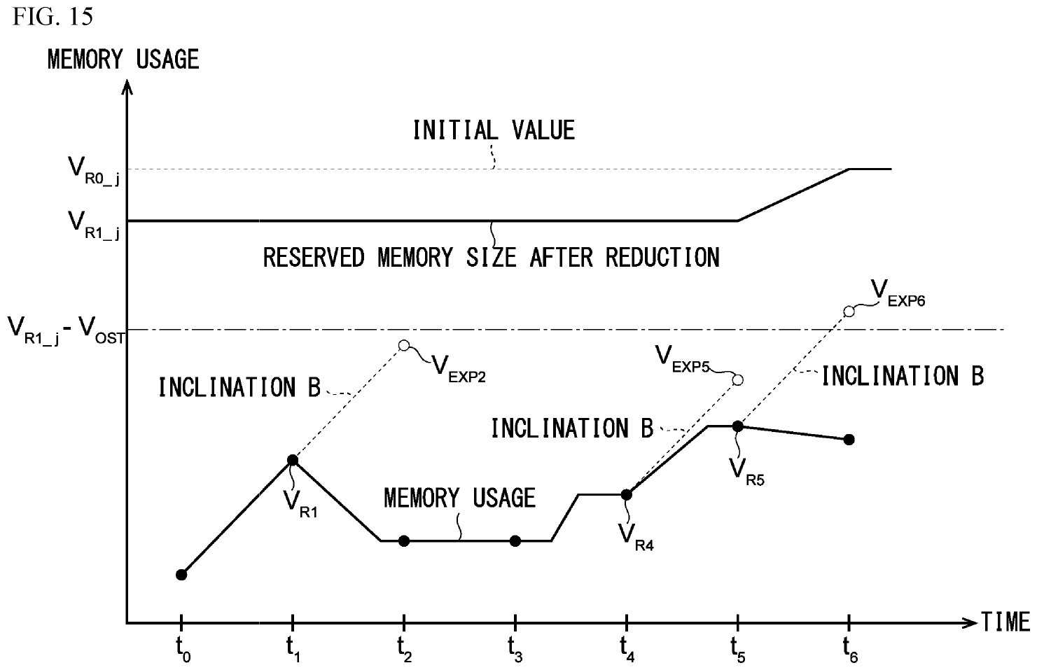

FIG. 15 is a schematic diagram illustrating the identification process. A horizontal axis of FIG. 15 indicates a time, and a vertical axis thereof indicates the memory usage of the j-th virtual machine 35.

In this example, it is assumed that the initial value of the reserved memory size of the j-th virtual machine 35 is V_{R0_j}, as illustrated in FIG. 15. Then, it is assumed that the reserved memory size is reduced to V_{R1_j} in the reduction process in step S25.

In this case, the prediction unit 68 calculates an estimated value V_{EXP(i+1)} of the memory usage at a time tᵢ₊₁ based on a memory usage V_{Ri} at a current time tᵢ. As an example, the prediction unit 68 identifies a maximum value B in inclinations of the memory usage in all the periods [tᵢ₋₁, tᵢ] before the current time tᵢ. Then, the prediction unit 68 calculates the estimated value V_{EXP(i+1)} of the memory usage at the time tᵢ₊₁ by extrapolating the memory usage V_{Ri} at the time tᵢ with the maximum value B of the inclination. When the estimated value V_{EXP(i+1)} exceeds V_{R1_j}−V_{OST}, the prediction unit 68 determines that the memory usage of the virtual machine 35 is likely to reach a reserved memory size V_{R1_j}.

In the example of FIG. 15, since an estimated value V_{EXP2} does not exceed V_{R1_j}−V_{OST}, the prediction unit 68 determines at a time t₁ that the memory usage of the virtual machine 35 does not reach the reserved memory size V_{R1_j} at a time t₂. On the other hand, since an estimated value V_{EXP6} exceeds V_{R1_j}−V_{OST}, the prediction unit 68 determines at a time t₅ that the memory usage of the virtual machine 35 is likely to reach the reserved memory size V_{R1_j} at a time t₆.

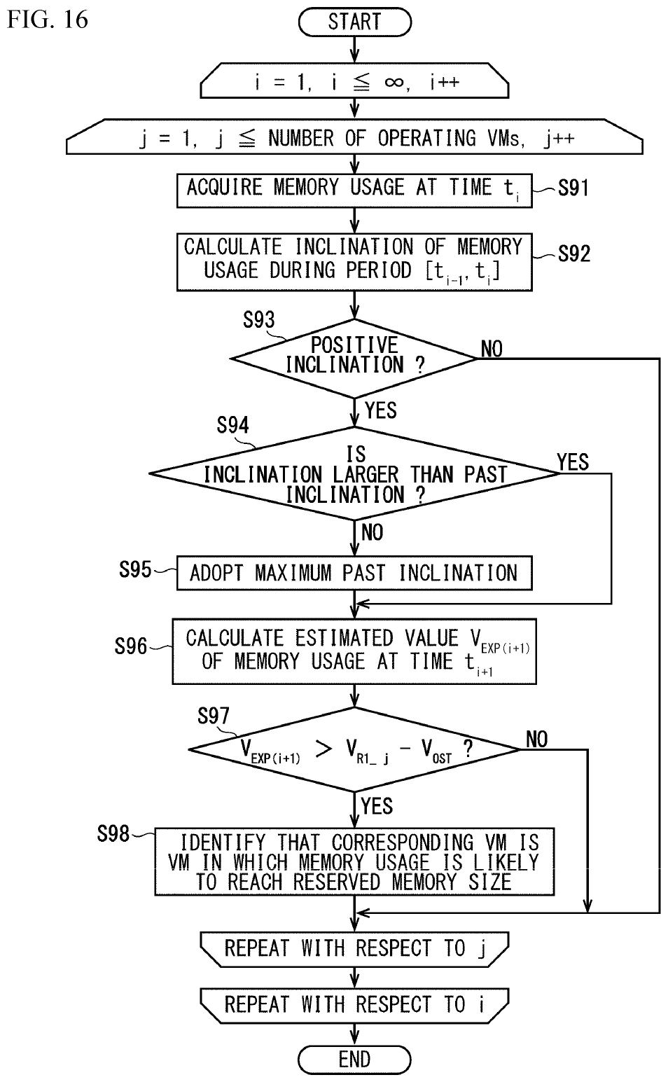

FIG. 16 is a flowchart illustrating the identification process. First, the prediction unit 68 acquires the memory usage of the j-th virtual machine 35 at the time tᵢ by referring to the resource information 64 (step S91).

Next, the prediction unit 68 calculates an inclination of the memory usage during the period [ti−1, ti] (step S92), and determines whether the inclination is positive (step S93).

Here, when it is determined that the inclination is not positive, the process completes.

On the other hand, when it is determined that the inclination is positive (step S93: YES), the process proceeds to step S94.

In step S94, the prediction unit 68 determines whether the inclination calculated in step S92 is larger than the inclinations in all the periods before the period [tᵢ₋₁, tᵢ].

Here, when the inclination calculated in step S92 is not larger than the inclinations in all the periods before the period [tᵢ₋₁, tᵢ] the process proceeds to step S95. In step S95, the prediction unit 68 adopts the maximum value B of the inclination in all the periods before the period [tᵢ₋₁, tᵢ].

On the other hand, when the inclination calculated in step S92 is larger than the inclinations in all the periods before the period [tᵢ₋₁, tᵢ] (step S94: YES), the process skips step S95. In this case, the inclination calculated in step S92 becomes the maximum value B of the inclination in all the periods including the period [tᵢ₋₁, tᵢ].

Next, the prediction unit 68 calculates the estimated value V_{EXP(i+1)} of the memory usage at the time tᵢ₊₁ using the maximum value B (step S96). As an example, the prediction unit 68 calculates the estimated value V_{EXP(i+1)} of the memory usage at the time tᵢ₊₁ by extrapolating the memory usage V_{Ri} at the time tᵢ with the maximum value B of the inclination, as illustrated in FIG. 15.

Next, the prediction unit 68 determines whether the estimated value V_{EXP(i+1)} exceeds V_{R1_j}−V_{OST} (step S97). Here, when it is determined that the estimated value V_{EXP(i+1)} exceeds V_{R1_j}−V_{OST}, the process proceeds to step S98.

In step S98, the prediction unit 68 identifies that the virtual machine 35 is a virtual machine that is likely to reach the reserved memory size V_{R1_j}.

On the other hand, when it is determined that the estimated value V_{EXP(i+1)} does not exceed V_{R1_j}−V_{OST}, the process skips step S98.

Then, the above steps S91 to S98 are executed for each of the variable i and the variable j, and the process is completed.

According to the identification process described above, when the estimated value V_{EXP(i+1)} of the memory usage at the time tᵢ₊₁ exceeds V_{R1_j}−V_{OST}, the prediction unit 68 identifies that the j-th virtual machine 35 is the virtual machine that is likely to reach the reserved memory size V_{R1_j}. Thereby, the memory size of the virtual machine 35 is returned to the initial value in step S81, which can prevent the actual memory usage from exceeding the reserved memory size.

### (Hardware Configuration)

Next, a description is given of the hardware configuration of each of the physical server 22 and the resource adjustment device 23.

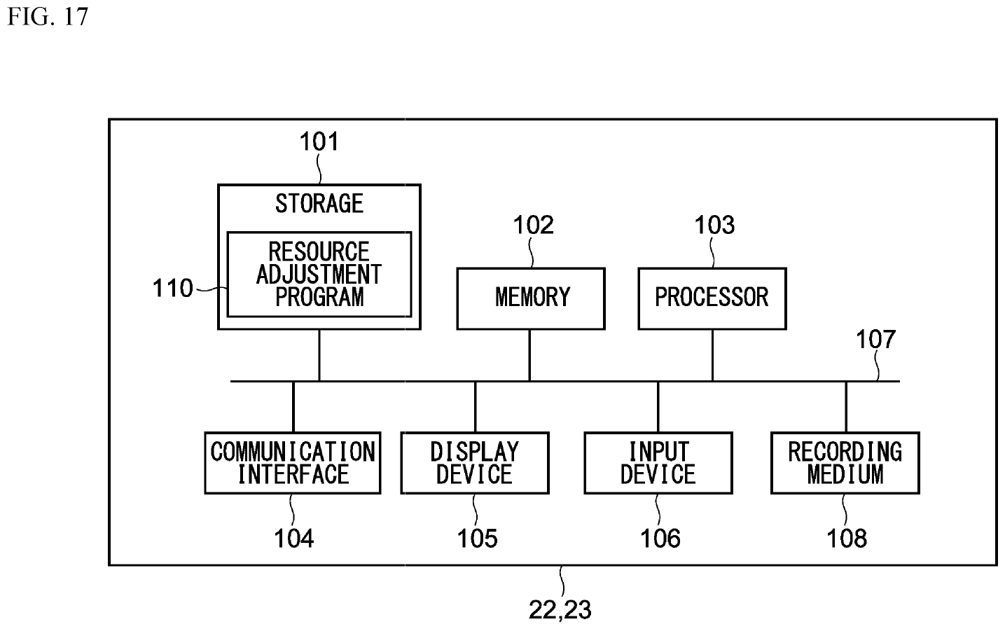

FIG. 17 is a hardware configuration diagram of each of the physical server 22 and the resource adjustment device 23.

As illustrated in FIG. 17, each of the physical server 22 and the resource adjustment device 23 includes a storage 101, a memory 102, a processor 103, a communication interface 104, a display device 105 and an input device 106. These elements are connected to each other by a bus 107.

The storage 101 is a non-volatile storage device such as an HDD (Hard Disk Drive) or an SSD (Solid State Drive), and stores a resource adjustment program 110 according to the present embodiment.

The resource adjustment program 110 may be recorded on a computer-readable recording medium 108, and the processor 103 may read the resource adjustment program 110 from the recording medium 108.

Examples of such a recording medium 108 include physically portable recording media such as a CD-ROM (Compact Disc-Read Only Memory), a DVD (Digital Versatile Disc), and a USB (Universal Serial Bus) memory. Further, a semiconductor memory such as a flash memory, or a hard disk drive may be used as the recording medium 108. The recording medium 108 is not a temporary medium such as a carrier wave having no physical form.

Further, the resource adjustment program 110 may be stored in a device connected to a public line, the Internet, a LAN (Local Area Network), or the like. In this case, the processor 103 may read and execute the resource adjustment program 110.

Meanwhile, the memory 102 is hardware that temporarily stores data, such as a DRAM (Dynamic Random Access Memory), and the resource adjustment program 110 is deployed on the memory 102.

The processor 103 is hardware such as a CPU (Central Processing Unit) or a GPU (Graphical Processing Unit) that controls each element of the physical server 22 and the resource adjustment device 23. Further, the processor 103 executes the resource adjustment program 110 in cooperation with the memory 102.

Thus, the processor 103 executes the resource adjustment program 110 in cooperation with the memory 102, and hence the control unit 54 of the physical server 22 (see FIG. 4) and the control unit 63 of the resource adjustment device 23 (see FIG. 6) are realized. The control unit 54 includes the virtual machine setting unit 55, the virtual machine execution unit 56, the acquisition unit 57, and the notification unit 58. Further, the control unit 63 includes the ranking setting unit 66, the allocation control unit 67, the prediction unit 68, and the charge calculation unit 69.

The storage unit 62 (see FIG. 6) is realized by the storage 101 and the memory 102.

Further, the communication interface 104 is hardware such as a NIC for connecting each of the physical server 22 and the resource adjustment device 23 to the network 21 (see FIG. 2). Each of the communication unit 51 of the physical server 22 (see FIG. 4) and the communication unit 61 of the resource adjustment device 23 (see FIG. 6) is realized by the communication interface 104.

The display device 105 is hardware such as a liquid crystal display or a touch panel for realizing each of the display unit 52 of the physical server 22 (see FIG. 4) and the display unit 59 of the resource adjustment device 23 (see FIG. 6).

The input device 106 is hardware such as a keyboard and a mouse for realizing each of the input unit 53 of the physical server 22 (see FIG. 4) and the input unit 60 of the resource adjustment device 23 (see FIG. 6).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A resource adjustment device, comprising:
a memory; and
a processor coupled to the memory and the processor configured to:
set a ranking to each of a plurality of first virtual machines according to an amount of resource used by each of the plurality of first virtual machines in operation; and
allocate the resource of the first virtual machine having a highest of the ranking to a second virtual machine before starting.

2. The resource adjustment device as claimed in claim 1, wherein
the processor allocates the resource to a third virtual machine in operation, the third virtual machine being different from each of the plurality of first virtual machines and the second virtual machine, and
allocates the resource allocated to the third virtual machine to the second virtual machine.

3. The resource adjustment device as claimed in claim 1, wherein
the processor allocates the resource of each of the plurality of the first virtual machines to the second virtual machine according to the ranking.

4. The resource adjustment device as claimed in claim 1, wherein
after the resource is allocated to the second virtual machine, the processor predicts whether an amount of the resource actually used by the first virtual machine reaches an amount of the resource reserved for the first virtual machine,
when the processor predicts that the amount of the resource actually used by the first virtual machine reaches the amount of the resource reserved for the first virtual machine, the processor increases the amount of the resource reserved for the first virtual machine.

5. The resource adjustment device as claimed in claim 1, wherein
after the resource is allocated to the second virtual machine, the processor calculates a charge of a system constructed by the plurality of first virtual machines according to the amount of the resource used by each of the plurality of first virtual machines.

6. The resource adjustment device as claimed in claim 1, wherein
the ranking is in a descending order of an average value of an amount of the resource not used by each of the plurality of first virtual machines in a predetermined period.

7. The resource adjustment device as claimed in claim 1, wherein
the ranking is in an ascending order of a variation in the amount of the resource used by each of the plurality of first virtual machines in a predetermined period.

8. A non-transitory computer-readable medium having stored therein a program for causing a computer to execute a process, the process comprising:
setting a ranking to each of a plurality of first virtual machines according to an amount of resource used by each of the plurality of first virtual machines in operation; and
allocating the resource of the first virtual machine having a highest of the ranking to a second virtual machine before starting.

9. A resource adjustment method for causing a computer to execute a process, the process comprising:
setting a ranking to each of a plurality of first virtual machines according to an amount of resource used by each of the plurality of first virtual machines in operation; and
allocating the resource of the first virtual machine having a highest of the ranking to a second virtual machine before starting.
